(19) United States
(12) Patent Application Publication
(10) Pub. No.: US 2008/0035866 A1
(43) Pub. Date: Feb. 14, 2008

(54) Mail imaging system with UV illumination interrupt

(75) Inventors: Mark D. Goodwin, Apalachin, NY (US); Mathew S. Hale, Barton, NY (US)

Correspondence Address: Lockheed Martin Corporation;c/o WOLF, GREENFIELD & SACKS, P.C., 600 ATLANTIC AVENUE, BOSTON, MA, 02210-2206, US

(73) Assignee: Lockheed Martin Corporation, Bethesda, MD (US)

(21) Appl. No.: 11/824,933

(22) Filed: Jul. 3, 2007

Related U.S. Application Data
(60) Provisional application No. 60/819,414, filed on Jul. 7, 2006.

(51) Int. Cl. G21K 1/00

(52) U.S. Cl. 250/505.1

(57) ABSTRACT

A UV illumination source interrupt may prevents emission of UV illumination from the UV illumination source in a mail processing system based on a detected presence of a mailpiece near a window at which the mailpiece may be illuminated with UV light. The UV source may also be controlled based on detected movement associated with a UV shield which may indicate potential exposure of an operator to UV light.

This application claims the benefit of U.S. Provisional Application No. 60/819,414, filed Jul. 7, 2006, which is hereby incorporated by reference in its entirety.

### FIELD OF INVENTION

This invention relates generally to imaging assemblies, and more particularly to an imaging assembly that controls imaging illumination based on object location and/or other conditions external to the imaging assembly.

### BACKGROUND OF INVENTION

Imaging systems have been implemented in numerous industrial and commercial settings, such as on high-speed mail sorting systems. In one implementation, a line scan camera may be fixed in a stationary position and mail items may be conveyed within the camera's field of view via a conveyor. As the mail items enter the field of view, they may be imaged by the camera, e.g., using a CCD imaging device. Image data captured by the camera may be analyzed (e.g., for determining if the mail has suitable postage, for determining the destination address for the mail, etc.) or otherwise processed.

Often, line scan cameras are implemented on mail sorting systems as part of a camera assembly. For example, many line scan cameras reside in a housing which protects the camera's components from the operating environment, e.g., external dust, dirt, humidity, etc. The camera assembly may, for example, define a window which provides the camera with a field of view toward mail items on the conveyor path. In addition, because many line scan cameras require a mail item to be illuminated with relatively bright light to capture an accurate image, the camera assembly may include lighting components, such as fluorescent, halogen or sodium vapor lamps, or light emitting diodes (LEDs) to illuminate an item to be imaged. Further, many camera assemblies include components to cool the assembly, since lighting and/or image capture components may produce sufficient heat to reduce the useful life of other components inside the housing.

### SUMMARY OF INVENTION

In one aspect of the invention, an imaging illumination system for use with a mail processing apparatus includes an illumination assembly with at least one ultraviolet (UV) illumination source, and a housing with at least one window through which the UV illumination source emits UV illumination to illuminate a mailpiece. The UV illumination may be used, for example, to cause markings on the mailpiece, such as a meter mark or other indicia formed with special ink, to fluoresce or phosphoresce. The fluorescent or phosphorescent illumination may be detected and used to process the mailpiece, e.g., determine where on the mailpiece a meter mark or other feature is located. A UV illumination source interrupt may prevent emission of UV illumination from the UV illumination source through the at least one window based on a detected presence/absence of a mailpiece near the at least one window. For example, the UV illumination source interrupt may include a sensor that detects movement of a mailpiece along a conveyor near the housing and control the UV illumination source so that it is disabled, or does not emit UV illumination, during periods when there is no mailpiece to be illuminated, but active when a mailpiece is positioned to be illuminated. This arrangement may extend the life of the UV source and/or help reduce emission of potentially harmful UV light, although UV light emitted by the camera might not be harmful, depending on the illumination band (spectra) and power.

In another aspect of the invention, a method for providing imaging illumination for use with a mail processing apparatus includes providing a housing having at least one window constructed and arranged to interact with a mailpiece, and providing a UV illumination source in the housing. UV illumination from the UV illumination source may be directed toward the at least one window and one or more mailpieces located near the housing, e.g., to illuminate a mailpiece. Emission of UV illumination may be enabled based on detected presence of a mailpiece near the housing, e.g., so that UV light is only emitted through the window when a mailpiece is located adjacent the window.

In another aspect of the invention, a mail processing system may include a UV illumination shield, e.g., one or more panels, walls or other structure that may help shield human operators from exposure to UV illumination. A UV source interrupt may control a UV source based on detected movement of a UV shield portion and/or preparatory action for movement of the shield portion. For example, a shield that houses a mailpiece imaging camera, conveyor and other portions of the mail processing system may have a door, access panel or other arrangement to allow an operator access to the system. The UV source interrupt may detect movement of the door or access panel, or detect preparatory movement such as movement of a door handle or lock that precedes opening of the door or panel. In response, the UV source interrupt may disable the UV source.

These and other aspects of the invention will be apparent from the following description and claims.

### BRIEF DESCRIPTION OF THE DRAWINGS

Aspects of the invention are described below with reference to illustrative embodiments, wherein like numerals reference like elements, and wherein:

FIG. 1 is a perspective view of an imaging illumination system in a mail processing system in accordance with aspects of the invention;

FIG. 2 is a top schematic view of the imaging illumination system of FIG. 1; and

FIG. 3 shows one illustrative embodiment of a shield for a mail processing system portion in accordance with an aspect of the invention.

### DETAILED DESCRIPTION

It should be understood that aspects of the invention are described herein with reference to the figures, which show illustrative embodiments in accordance with aspects of the invention. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

In one aspect of the invention, an imaging illumination system for use in a mail processing system includes a housing that contains an imaging illumination source, such as a UV illumination source, and an imaging device, which may include a CCD device with associated optical lenses or other components, one or more phototransistors, or any other light sensitive device suitable for capturing image information. The housing may serve to protect the illumination source, imaging device and other components from environmental conditions outside of the housing, such as dirt, dust, humidity, extreme temperatures, and so on. The housing may have at least one window, for example, a rectangular slit-like opening, through which imaging illumination may exit the housing to illuminate a mailpiece located near the window. Illumination from the mailpiece (whether reflected, fluorescent, or otherwise emanating from the mailpiece) may pass through the window or another opening in the housing for detection by the imaging device. As a result, the imaging illumination system may capture image information of mailpieces located near the housing for use in routing the mailpieces or other processing.

For example, the system may emit UV illumination through a window in the housing to illuminate a mailpiece. The mailpiece may include special ink or other markings that fluoresce visible light when illuminated with UV light. For example, some meter marks or other indicia formed on mailpieces emit a reddish light when exposed to UV light. As another example, some barcodes formed on mailpieces emit an orange light when exposed to UV light. In another embodiment, postage stamps affixed to mailpieces may emit a green light when exposed to UV light. The fluorescent light from the mailpiece indicia may be captured by the imaging device to form image information for the mailpiece.

The imaging illumination system may include a UV illumination source interrupt that prevents emission of UV illumination from the window, e.g., to extend the useful life of the UV source and/or to protect human operators from potentially harmful exposure. It should be noted that not all UV light is harmful to humans, particularly in the longer wavelengths (UVA) and with lower power. The UV illumination source interrupt may control operation of the UV illumination source based on detected movement near the housing, e.g., the presence of a mailpiece near the housing and approaching the window. For example, the imaging illumination system may include a mailpiece presence sensor (such as a photodetector) that detects the presence of a mailpiece on a conveyor that moves mailpieces in serial fashion along a downstream direction past the window in the housing. The mailpiece presence sensor may be positioned upstream of the window, and indicate arrival of each mailpiece at the window. Since there typically is space between mailpieces on the conveyor, the UV illumination source interrupt may disable the UV illumination source when no mailpiece is located near the window. That is, the UV illumination source interrupt may enable the UV illumination source to emit light only when a mailpiece is in position for illumination and imaging at the window, but disable the UV source when no mailpiece is located near the window. By disabling the UV source, the life of the UV source (whether a UV tube, UV LED or other light emitting component) may be extended and/or emission of unused UV light may be reduced.

The UV illumination source interrupt may also control the UV source based on other detected movement, such as movement of lock for a door or other shield portion of shield arranged to block UV light emitted from the housing window from reaching human-inhabited areas. For example, a mailpiece processing line may include a shield that protects human operators from mechanical components of the line, as well as from potentially harmful UV light. The shield may have one or more access openings, e.g., to allow an operator to make repairs, view the line operation, and so on. Movement of a shield portion for an access opening may be detected, e.g., by microswitch or other arrangement, causing the UV illumination source interrupt to disable the UV source. Movement of the shield portion that is detected may include actual movement of a door, panel or other UV shielding component and/or movement of a handle, lock, tab or other component in preparation for movement of the shield portion. In one illustrative embodiment, a portion of the UV illumination source interrupt that detects movement of a shield portion may be made entirely of hardware components, i.e., not include any software components, such as a switch that causes power and/or control signals to the UV source to be interrupted. Such an arrangement may provide for more reliable operation in some embodiments, since the UV source interrupt may not be compromised by potential software malfunction.

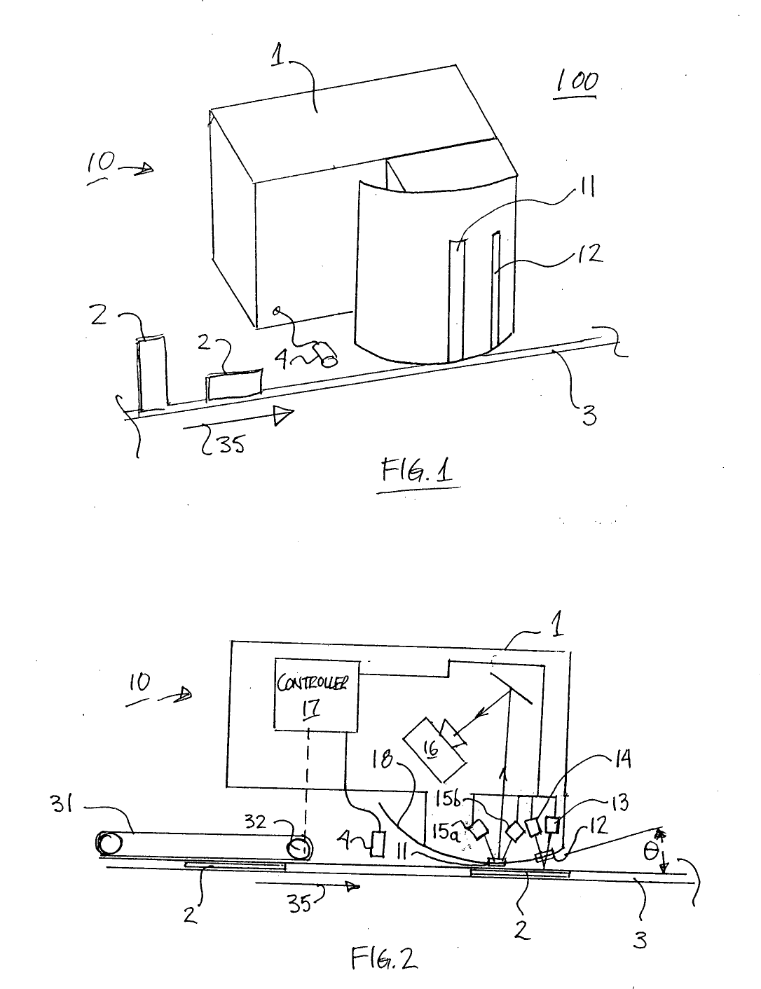

FIG. 1 shows a perspective schematic view of a mail processing system 100 having an imaging illumination system 10 for illuminating and imaging mailpieces 2 that are moved along path in a downstream direction (see arrow 35) by a conveyor 3. In this illustrative embodiment, the imaging illumination system 10 includes a housing 1 with first and second windows 11 and 12 used to transmit illumination for imaging mailpieces 2 as they travel with the conveyor 3. The windows 11 and 12 may include a transparent member, such as a sapphire plate, that covers each window and helps prevent dust, dirt or other contaminants from entering the housing 1. Alternatively, the windows 1 1 and 12 may include a semi-transparent member, such as an optical filter to alter the properties of the illumination or of the returned image, that may also cover the each window and help prevent dust, dirt or other contaminants from entering the housing 1. The transparent member may also be arranged to make contact with mailpieces 2 as they pass the window, e.g., the conveyor 3 may press mailpieces against the window 11 when adjacent to the window 11. The windows 11 and 12 may be used in any suitable way for illuminating and/or imaging mailpieces 2. For example, in this illustrative embodiment, mailpieces 2 are illuminated by a visible light source and imaged by a first imaging device at a first window 11, and are illuminated by a UV light source and imaged by a second imaging device at a second window 12. However, it should be understood that mailpieces may be illuminated at one window and imaged at another window, illuminated and imaged at only a single window, etc. Also, although in this embodiment the first window 11 is arranged to contact mailpieces and the second window 12 does not typically make contact with mailpieces, both windows may be arranged to make contact (or not) with mailpieces 2. In short, the windows 11 and 12 may be arranged in any suitable way, have any suitable size and/or shape, etc.

The imaging illumination system 10 also includes a mailpiece presence sensor 4 that detects the presence of mailpieces 2 as they move near the housing 1 along the conveyor 3. Typically, mailpieces 2 will have some space between them on the conveyor 3, e.g., as shown in FIG. 1. Thus, there will be periods when there is no mailpiece 2 located at the window 11 or 12 whether for illumination or imaging purposes. During these periods, one or more illumination sources in the imaging illumination system 10 need not emit illumination. By disabling the illumination source(s), the life of the illumination source(s) may be extended, and emission of unused illumination may be avoided.

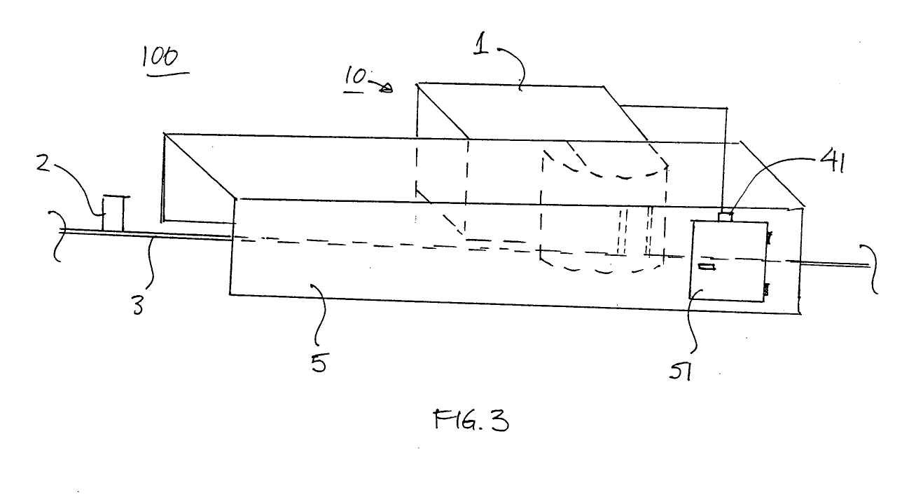

FIG. 2 shows a top schematic diagram of the imaging illumination system 10. In this illustrative embodiment, the housing 1 encloses a visible light source 15 and a UV illumination source 13, which each respectively produce illumination to illuminate a mailpiece 2 located adjacent the first and second windows 11 and 12. Illumination from the visible light source 15 that is reflected from the mailpiece 2 adjacent the first window 11 may be received by a first imaging device 16 and used to capture image information for the mailpiece 2. Similarly, illumination from the UV illumination source 13 may cause light to be emitted from the mailpiece 2 and through the second window for detection by a second imaging device 14. The visible light source 15 and UV illumination source 13 may include any suitable components for producing desired light to illuminate a mailpiece 2. For example, in this illustrative embodiment, the visible light source 15 may include one or more light emitting devices (LEDs) arranged to emit light from the first window 11. Any suitable number of LEDs may be used, and the LEDs may emit light of the same or different wavelengths. Also, any other suitable optical devices may be included in the visible light source 15, such as diffusers, lenses, homogenizers, diffraction devices, filters, or any other suitable device to operate on the light emitted by the LEDs in any suitable way. In this illustrative embodiment, the visible light source 15 includes two elements 15a and 15b on either side of the first window 11 that emit light at an angle relative to the downstream direction of the mailpieces 2 at the first window 11. Each element 15a and 15b includes three vertical columns each with 58 LEDs that extend along the length of the first window 11. Each column of LEDs has a repeating pattern of 2 white light emitting LEDs followed by 1 aqua light emitting LED. The elements 15a and 15b also each include a diffuser to homogenize the light emitted by the LEDs, e.g., to more uniformly illuminate the mailpieces 2 at the first window 11.

The UV illumination source 13 in this illustrative embodiment includes a vertical column of UV light emitting LEDs, e.g., having 26 total LEDs. Within the housing 1, the windows 11 and 12 and the light sources 14 and 15 are isolated from each other, e.g., so that UV light is not emitted through the first window 11, and visible light is not emitted through the second window 12. It should be understood that the visible light source 15 and the UV illumination source 13 may be arranged in any suitable way. For example, the UV illumination source 13 may include a UV tube, instead of LEDs and may include any other suitable optical elements (such as diffusers, lenses, filters, etc.) like the visible light source 15. Likewise, the visible light source 15 may include any suitable light emitting devices, such as one or more lamps or other.

The first and second imaging devices 16 and 13 may include any suitable components, such as a CCD imaging device, one or more phototransistors or other photodetectors, and/or any other suitable image sensing device. In this illustrative embodiment, the first imaging device 16 includes a CCD device along with suitable optical components, such as lenses, stops, focal length adjustment components, and others. Although not shown, this embodiment preferably includes at least one mirror to fold the optical axis of the first imaging device 16 to thereby make the space required for the first imaging device 16, and thus the housing 1, more compact. The second imaging device 14 in this embodiment includes a linear array of phototransistors, e.g., arranged in a column that extends along the length of the second window 12. The second imaging device 14 may also include a filter that passes only selected wavelengths of visible light, and otherwise blocks UV light. Thus, in this embodiment, the second imaging device 14 may detect visible light that is emitted from a mailpiece in response to being illuminated by UV light. As is known in the art, such an arrangement can allow for detection of meter and other markings on mail made with ink or other material that fluoresces (in this case emits visible light) in response to UV illumination. One possible advantage of using a small number of phototransistors is they may provide a short optical path that fits near the mailpiece, minimizing space requirements. The first and second imaging devices 16 and 13 may capture image information having any desired resolution. For example, in the case of the second imaging device 14, the phototransistors may be arranged to detect illumination from an area on a mailpiece such that each pixel in the image information corresponds to approximately a ¼ inch square area on the mailpiece 2. Such resolution may be suitable for finding the location of particular UV sensitive marks on mailpieces, such as meter marks, fluorescent barcodes and others. The first imaging device 16 may have significantly higher resolution, e.g., suitable for use in optical character recognition and other pattern recognition analyses.

Components of the imaging illumination system 10 may operate under the control of a controller 17, which may include any suitable components for performing desired signal input/output, and other functions. The controller 17 and/or higher level controller may include any suitable general purpose data processing system, which can be, or include, a suitably programmed general purpose computer, or network of general purpose computers, and other associated devices, including communication devices, and/or other circuitry or components necessary to perform the desired input/output or other functions. The controllers can also be implemented at least in part as single special purpose integrated circuits (e.g., ASICs), or an array of ASICs, each having a main or central processor section for overall, system-level control and separate sections dedicated to performing various different specific computations, functions and other processes under the control of the central processor section. The controller 17 can also be implemented using a plurality of separate dedicated programmable integrated or other electronic circuits or devices, e.g., hardwired electronic or logic circuits, such as discrete element circuits or programmable logic devices. The controller 17 may communicate with portions of the system 10 in any suitable way, such as by wired and/or wireless link, and in any suitable format and/or communications protocol. The controller may also include other devices, such as an information display device, user input devices, such as a keyboard, user pointing device, touch screen or other user interface, data storage devices, communication devices or other electronic circuitry or components.

As discussed above, the imaging illumination system 10 may include a mailpiece presence sensor 4 that detects each mailpiece on the conveyor 3 as the mailpiece approaches the housing 1. The sensor 4 may communicate with the controller 17 so that the controller 17 may control the other portions of the system 10 based on the mailpiece detection. For example, the controller 17 may receive information from an encoder 32 or other suitable sensor regarding the speed of a belt 31 of the conveyor 3. Based on this information, the controller 17 may know the speed at which mailpieces 2 are traveling on the conveyor 3 and therefore determine when a mailpiece detected by the presence sensor 4 will be adjacent the first and/or second windows 11 and 12. Thus, the controller 17 may control the visible light source 15, the UV illumination source 13, and the first and second imaging devices 16 and 13 to operate when the mailpiece is suitably located relative to the first and second windows 11 and 12. In this illustrative embodiment, a UV illumination source interrupt may include the controller 17 and the presence sensor 4 (and optionally the encoder 32, if provided), and may control the UV illumination source 13 to emit light only when the mailpiece is located at the second window 12. Otherwise, when no mailpiece 2 is located at the second window 12, the UV illumination source 13 may be disabled.

In accordance with another aspect of the invention, the UV illumination source interrupt may be arranged to disable the UV illumination source upon detection of movement regarding a shield used with a mail processing system 100. FIG. 3 shows an illustrative embodiment of a mail processing system 100 that incorporates the imaging illumination system 10, conveyor 3, and a shield 5 that at least partially encloses portions of the mail processing system 100. The shield 5 may function to help protect human operators around the mail processing system 100 from potentially dangerous contact with the conveyor 3 and/or other portions of the system 100. Also, the shield 5 may help protect operators from exposure to UV illumination emitted by the imaging illumination device 10. That is, UV illumination may be emitted from the second window 12 during operation, and exposure of the human eye to such light may cause damage to the eye. The shield 5 may help reduce potentially harmful exposure, while also providing operators selective access to the mail processing system 100. For example, the shield 5 may include a portion 51 (such as a door) that is movable to expose a portion of the conveyor 3 or other part of the system 100. The portion 51 may be arranged in any suitable way, such as a hinged door with a handle to lock/unlock the door, a removable panel, or other suitable arrangement. A switch 41, such as a microswitch, may be arranged to detect movement related to the portion 51 that may expose an operator to UV illumination, and cause the UV illumination source 13 to be disabled. For example, the switch 41 may detect movement of a removable panel, movement of a handle on a door, movement of a lock that secures the portion 51 in a closed position, or other. In one embodiment, the UV illumination source interrupt may include only hardware portions to disable the UV source when movement regarding a shield portion is detected. Thus, no software or other programmed computer operation may be required to disable the UV source based on detected shield portion movement. For example, the switch 41 may be arranged in the UV source circuitry such that opening (or closing) of the switch suitably disables or enables the UV source.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An imaging illumination system for use with a mail processing apparatus, comprising:
an illumination assembly including at least one UV illumination source;
a housing with at least one window through which the UV illumination source emits UV illumination to illuminate a mailpiece; and
a UV illumination source interrupt that prevents emission of UV illumination from the UV illumination source through the at least one window based on a detected absence of a mailpiece near the at least one window.

2. The system of claim 1, wherein the UV illumination source interrupt includes a sensor that detects movement of a mailpiece along a conveyor.

3. The system of claim 2, wherein the UV illumination source interrupt is arranged to disable the UV illumination source between detection of two adjacent mailpieces moved along the conveyor.

4. The system of claim 1, wherein the UV illumination source interrupt includes a photosensor adapted to detect the presence of a mailpiece.

5. The system of claim 1, wherein the UV illumination source interrupt is arranged to detect movement of a mailpiece conveyor, and disables the UV illumination source in response to stoppage of the conveyor.

6. The system of claim 1, further comprising an indicator that provides a human-detectable indication that the UV illumination source is producing UV illumination.

7. The system of claim 6, wherein the indicator includes an indicator light visible from an exterior of the housing.

8. The system of claim 1, further comprising:
at least one belt constructed and arranged to move mailpieces relative to the at least one window.

9. The system of claim 8, further comprising:
an image capture device constructed and arranged to detect image information from illumination emitted from the mailpieces as a result of the UV illumination.

10. The system of claim 1, further comprising a UV radiation shield arranged to block UV illumination emitted from the at least one window, the UV radiation shield having at least one shield portion, and wherein the UV illumination source interrupt includes a switch that is actuated in response to movement of the at least one shield portion and/or preparatory action for movement of the at least one shield portion.

11. A method for providing imaging illumination for use with a mail processing apparatus, comprising:
providing a housing having at least one window constructed and arranged to interact with a mailpiece;
providing a UV illumination source in the housing;
providing UV illumination from the UV illumination source, the UV illumination being directed toward the at least one window and one or more mailpieces located near the housing; and
enabling emission of UV illumination based on detected presence of a mailpiece near the housing.

12. The method of claim 11, further comprising disabling the UV illumination source based on detected non-presence of a mailpiece near the housing.

13. The method of claim 11, wherein the step of enabling emission comprises detecting movement of a mailpiece near the at least one window.

14. The method of claim 11, further comprising:
moving a plurality of mailpieces in series near the at least one window; and wherein the step of enabling emission comprises:
enabling emission of the UV illumination when each mailpiece is detected to be near the at least one window; and
disabling emission of the UV illumination when mailpieces are not detected to be near the at least one window.

15. The method of claim 11, further comprising:
moving one or more mailpieces near the housing, and wherein the step of enabling emission comprises disabling the UV illumination source in response to stoppage of mailpieces near the housing.

16. The method of claim 11, further comprising:
moving one or more mailpieces near the housing with a conveyor, and wherein the step of preventing emission comprises disabling the UV illumination source in response to stoppage of the conveyor.

17. The method of claim 11, further comprising providing a human-detectable indication that the UV illumination source is producing UV illumination.

18. The method of claim 11, further comprising:
capturing image information from mailpieces illuminated by the UV illumination.

19. The method of claim 11, further comprising:
providing a UV illumination shield adapted to block UV illumination emitted from the at least one window; and
disabling emission UV illumination based on detecting movement of at least one shield portion of the UV illumination shield and/or preparatory action for movement of the at least one shield portion.

20. The method of claim 11, wherein the step of providing UV illumination comprises emitting UV illumination in the UVA (approximately 320-400 nm), UVB (approximately 280-320 nm) and/or UVC (approximately 100-280 nm) regions, and the UV illumination source includes a mercury vapor tube or a plurality of LEDs.
